(19) United States
(12) Patent Application Publication
(10) Pub. No.: US 2026/0059358 A1
(43) Pub. Date: Feb. 26, 2026

(54) METHODS AND APPARATUSES FOR TRANSMITTING CSI FEEDBACK MESSAGE

(71) Applicant: LENOVO (BEIJING) LIMITED, Beijing (CN)

(72) Inventors: Chenxi Zhu, Beijing (CN); Yi Zhang, Beijing (CN); Bingchao Liu, Beijing (CN); Wei Ling, Beijing (CN); Lingling Xiao, Beijing (CN)

(21) Appl. No.: 19/102,484

(22) PCT Filed: Aug. 11, 2022
(86) PCT No.: PCT/CN2022/111696

§ 371 Date: Feb. 10, 2025

(51) Int. Cl. H04W 24/08; H04L 5/00

(52) U.S. Cl. CPC H04W 24/08; H04L 5/0048

(57) ABSTRACT

The present application relates to methods and apparatuses for transmitting a channel state information (CSI) feedback message. An embodiment of the present disclosure provides a user equipment (UE), comprising: a transceiver configured to: receive a CSI report configuration message indicating a plurality of channel state information reference signal (CSI-RS) resources for channel measurement and at least one zero-power or non-zero power CSI-RS resource for interference measurement, wherein each CSI-RS resource of the plurality of CSI-RS resources is associated with a CSI-RS resource indicator (CRI) and an identical number of CSI-RS ports; and a processor coupled with the transceiver and configured to: perform a channel measurement procedure based on the CSI report configuration message; and select a set of CSI-RS resources from the plurality of CSI-RS resources for a joint transmission based on the channel measurement procedure; wherein the transceiver is further configured to: transmit a CSI feedback message after the channel measurement procedure is performed, wherein the CSI feedback message includes a single rank indicator (RI), a single channel quality indicator (CQI), and a set of precoding matrix indicators (PMIs), wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

### TECHNICAL FIELD

The present disclosure relates to wireless communication, and particularly relates to methods and apparatuses for transmitting a channel state information (CSI) feedback message.

### BACKGROUND OF THE INVENTION

The continuing evolution of multiple input multiple output (MIMO) may be the most important part of 3^{rd} generation partnership project (3GPP) physical layer. It is important to identify and specify necessary enhancements for both downlink and uplink MIMO for facilitating the use of large antenna array, not only for frequency range 1 (FR1) but also for FR2 to fulfil the request for evolution of new radio (NR) deployments in Rel-18.

As coherent joint transmission (CJT) improves coverage and average throughput in commercial deployments with high-performance backhaul and synchronization, enhancements on CSI acquisition for frequency division duplex (FDD) and time division duplex (TDD), targeting FR1, can be beneficial in expanding the utility of multiple transmission or reception points (TRPs) deployments.

Therefore, it is advantageous to provide improved methods and apparatuses for transmitting a CSI feedback message.

### SUMMARY

Some embodiments of the present disclosure provide a user equipment (UE), comprising: a transceiver configured to: receive a CSI report configuration message indicating a plurality of channel state information reference signal (CSI-RS) resources for channel measurement and at least one zero-power or non-zero power CSI-RS resource for interference measurement, wherein each CSI-RS resource of the plurality of CSI-RS resources is associated with a CSI-RS resource indicator (CRI) and an identical number of CSI-RS ports; and a processor coupled with the transceiver and configured to: perform a channel measurement procedure based on the CSI report configuration message; and select a set of CSI-RS resources from the plurality of CSI-RS resources for a joint transmission based on the channel measurement procedure; wherein the transceiver is further configured to: transmit a CSI feedback message after the channel measurement procedure is performed, wherein the CSI feedback message includes a single rank indicator (RI), a single channel quality indicator (CQI), and a set of precoding matrix indicators (PMIs), wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

In some embodiments, each PMI of the set of PMIs is based on an eType 2 codebook, and includes a phase of a strongest frequency domain component of each data layer.

In some embodiments, each PMI of the set of PMIs incorporates a number of phase adjustment factors, a total number of the phase adjustment factors equals a value of the RI, and each phase adjustment factor is associated with a data layer for the respective CSI-RS resource.

In some embodiments, each phase adjustment factor is associated with all sub-bands.

In some embodiments, each phase adjustment factor is associated with a respective sub-band.

In some embodiments, each PMI of the set of PMIs is based on an eType 2 codebook and includes a number of phase adjustment factors, a total number of the phase adjustment factors equals a value of the RI, and each phase adjustment factor is associated with a data layer for the respective CSI-RS resource.

In some embodiments, each phase adjustment factor is associated with a respective sub-band.

In some embodiments, each phase adjustment factor is associated with all sub-bands.

In some embodiments, each PMI of the set of PMIs includes an amplitude adjustment factor for a codeword associated with the respective CSI-RS resource.

Some other embodiments of the present disclosure provide a base station (BS), comprising: a transceiver configured to: transmit a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports; and receive a CSI feedback message including a single RI, a single CQI, and a set of PMIs, wherein each PMI of the set of PMIs is associated with a respective CSI-RS resource in a subset of the plurality of CSI-RS resources, and wherein the RI indicates a rank applied to each CSI-RS resource of the subset of the plurality of CSI-RS resources, and the CQI indicates a channel quality associated with all CSI-RS resources in the subset of the plurality of CSI-RS resources; and a processor coupled with the transceiver.

In some embodiments, each PMI of the set of PMIs is based on an eType 2 codebook, and includes a phase of a strongest frequency domain component of each data layer.

In some embodiments, each PMI of the set of PMIs incorporates a number of phase adjustment factors, a total number of the phase adjustment factors equals a value of the RI, and each phase adjustment factor is associated with a data layer for the respective CSI-RS resource.

In some embodiments, each phase adjustment factor is associated with all sub-bands.

In some embodiments, each phase adjustment factor is associated with a respective sub-band.

In some embodiments, each PMI of the set of PMIs is based on an eType 2 codebook and includes a number of phase adjustment factors, a total number of the phase adjustment factors equals a value of the RI, and each phase adjustment factor is associated with a data layer for the respective CSI-RS resource.

In some embodiments, each phase adjustment factor is associated with a respective sub-band.

In some embodiments, each phase adjustment factor is associated with all sub-bands.

In some embodiments, each PMI of the set of PMIs includes an amplitude adjustment factor for a codeword associated with the respective CSI-RS resource.

Yet some other embodiments of the present disclosure provide a method performed by a UE, comprising: receiving a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports; performing a channel measurement procedure based on the CSI report configuration message; selecting a set of CSI-RS resources from the plurality of CSI-RS resources for a joint transmission based on the channel measurement procedure; and transmitting a CSI feedback message after the channel measurement procedure is performed, wherein the CSI feedback message includes a single RI, a single CQI, and a set of PMIs, wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

Still some other embodiments of the present disclosure provide a method performed by a BS, comprising: transmitting a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports; and receiving a CSI feedback message including a single RI, a single CQI, and a set of PMIs, wherein each PMI of the set of PMIs is associated with a respective CSI-RS resource in a subset of the plurality of CSI-RS resources, and wherein the RI indicates a rank applied to each CSI-RS resource of the subset of the plurality of CSI-RS resources, and the CQI indicates a channel quality associated with all CSI-RS resources in the subset of the plurality of CSI-RS resources.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present disclosure.

FIG. 2 illustrates a flowchart of an exemplary method performed by a UE for transmitting a CSI feedback message according to some embodiments of the present disclosure.

FIG. 3 illustrates a method performed by a BS according to some embodiments of the present disclosure.

FIG. 4 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP long term evolution (LTE), LTE-Advanced (LTE-A), 3GPP 4G, 3GPP 5G NR, 3GPP Release 16 and onwards, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 is a schematic diagram illustrating an exemplary wireless communication system according to some embodiments of the present application.

Referring to FIG. 1, the wireless communication system may include a BS 101, a number of TRPs (e.g., TRP 103-1, TRP 103-2, . . . , TRP 103-N), and a UE 105. Although only one BS 101, three TRPs and one UE 105 are shown for simplicity, it should be noted that the wireless communication system may include more or less communication device(s), apparatuses, or node(s) in accordance with some other embodiments of the present application.

The wireless communication system is compatible with any type of network that is capable of sending and receiving wireless communication signals. For example, the wireless communication system is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The TRPs can communicate with the BS 101 via, for example, a backhaul link. Each of the TRPs can serve one or more UEs. As shown in FIG. 1, the TRP 103-1 can serve some mobile stations (which include the UE 105) within a serving area or region (e.g., a cell or a cell sector), the TRP 103-2 can serve some mobile stations (which include the UE 105) within a serving area or region (e.g., a cell or a cell sector), and the TRP 103-N can serve some mobile stations (which include the UE 105) within a serving area or region (e.g., a cell or a cell sector). In some embodiments, the TRP 103-1, the TRP 103-2, and the TRP 103-N may serve different UEs. The TRPs can communicate with each other via, for example, a backhaul link (not shown in FIG. 1).

The UE 105 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE 105 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE 105 may include wearable devices, such as smart watches, fitness bands, optical head-mounted displays, or the like. Moreover, the UE 105 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present application, the TRPs, for example, the TRP 103-1, the TRP 103-2, . . . , the TRP 103-N may perform CJT with the UE 105. All the TRPs involved in the CJT may have the same antenna configuration but are at different locations. The channels from these TRPs to the UE 105 are therefore independent, which may be represented as a matrix: H=[H₁ H₂ . . . . H_{N}], where the channel from the TRP 103-1 to the UE 105 may be represented as a vector: H₁, the channel from the TRP 103-2 to the UE 105 may be represented as a vector: H₂ . . . , and the channel from the TRP 103-N to the UE 105 may be represented as a vector: H_{N}.

Each TRP may be configured and transmit with a CSI-RS resource for channel measurement with the same number of antenna ports. Further, in the CJT, each TRP may transmit the same data to the UE 105.

The UE 105 may receive a CSI report configuration message (e.g., CSI-reportConfig), for example, via a radio resource control (RRC) signaling. The CSI report configuration message may indicate the CSI-RS resources for channel measurement each corresponding to a respective TRP. The number of CSI-RS resources for channel measurement may be based on a capability reported by the UE 105. The CSI report configuration message may also include at least one zero-power or non-zero power CSI-RS resource for interference measurement.

After receiving the CSI report configuration message, the UE 105 may perform a channel measurement procedure based on the information included in the CSI report configuration message. In particular, the UE 105 may conduct a channel measurement procedure for all the configured CSI-RS for channel measurement. After the measurement, the UE 105 then may select a set of CSI-RS resources from the CSI-RS resources for joint transmission based on the channel measurement procedure. The UE 105 may select the set of CSI-RS resources based on the UE capability, or a configuration from the network (e.g., from the BS 101), or both. The UE 105 may indicate the selected set of CSI-RS resources in a CSI feedback message transmitted to the network. In other words, the UE 105 may indicate the selected TRPs corresponding to the selected set of CSI-RS resources to the network, and the selected TRPs may be used to perform CJT with the UE 105.

The CSI feedback message may include the following information:
a single RI;
a single CQI; and
one or more PMIs, where each PMI is associated with a CSI-RS resource in the selected set of CSI-RS resources of the same rank as indicated by the RI.

The single RI may indicate a rank which is applied to each CSI-RS resource of the selected set of CSI-RS resources, and the single CQI may indicate a channel quality associated with all CSI-RS resources in the selected set of CSI-RS resources.

The present disclosure proposes that the precoding matrix for each TRP may be indicated by a PMI based on an eType 2 codebook with additional parameters to reflect different phases and/or different amplitudes between the selected TRPs. Each physical uplink shared control channel (PUSCH) layer may be transmitted by all the CSI-RS ports of all the selected TRPs.

It is assumed that the signal transmitted by each of N TRPs to a UE may be represented as “x,” the channel matrix may be represented as “H,” and the precoding matrix may be represented as “W.” An individual channel from TRP n (1≤n≤N) may be represented as Hₙ, and an individual precoder from TRP n may be represented as Wₙ. For example, Wₙ=W_{1,n}\tilde{W}_{2,n}W_{f,n}^{H} as specified in the 3GPP documents (such as TS 38.214), which may be the description of the channel in the spatial and frequency/temporal domain with selected CSI-RS resources (or selected beams) used for the transmission with a rank value of R (which may be indicated by the RI), and the detailed definition of each term in this expression can be found in the 3GPP documents and is omitted here for simplicity.

For CJT, the N TRPs may be geographically separated and the channels from the N TRPs to the same UE are independent. The present disclosure proposes to apply an amplitude adjustment factor, or a data-layer specific phase adjustment factor, or both, for each TRP. According to some embodiments, the present disclosure proposes a precoding matrix as follows:

$$W = [ \begin{matrix}( {a}_{1} ) \times {W}_{1 , 1} {\tilde{W}}_{2 , 1} {W}_{f , 1}^{H} {Q}^{1} \\ ⋮ \\ ( {a}_{N} ) \times {W}_{1 , N} {\tilde{W}}_{2 , N} {W}_{f , N}^{H} {Q}^{N}\end{matrix} ]$$

Where aₙ is the amplitude adjustment factor for TRP n, and

$${Q}^{n} = diag ( {q}^{n} ) = diag ( [ {q}_{1}^{n} , {q}_{2}^{n} , … , {q}_{R}^{n} ] ) ,$$

wherein

$${q}_{l}^{n}$$

is un phase adjustment favor for data layer l (1≤l≤R) for TRP n. Then, the signal received at the UE may be represented as:

$$y = HWx = [ {H}_{1} {H}_{2} … {H}_{N} ] Wx = {{\sum }_{n = 1}}^{N} {a}_{n} {H}_{n} {W}_{1 , n} {\tilde{W}}_{2 , N} {W}_{f , N}^{H} {Q}^{n} x$$

Based on Hₙ from TRP n estimated based on the corresponding CSI-RS resource, the UE may determine Wₙ for TRP n and the corresponding amplitude adjustment factor aₙ. Let

$${a}_{n} {H}_{n} {W}_{n} = {V}^{n} = [ {v}_{1}^{n} , … , {v}_{R}^{n} ] .$$

In the spatial domain, the vectors

$${v}_{1}^{n} , … , {v}_{R}^{n}$$

are mutually orthogonal so the UE may detect them without mutual interference. It then follows that

$$y = {{\sum }_{n = 1}}^{N} {a}^{n} {H}_{n} {W}_{n} {Q}^{n} x = {{\sum }_{n = 1}}^{N} {V}^{n} {Q}^{n} x = {{\sum }_{n = 1}}^{N} [ {v}_{1}^{n} , … , {v}_{R}^{n} ] [ \begin{matrix}{p}_{1}^{n} {x}_{1} \\ … \\ {p}_{R}^{n} {x}_{R}\end{matrix} ] = {{\sum }_{n = 1}}^{N} ( {{\sum }_{r = 1}}^{R} {v}_{r}^{n} {q}_{r}^{n} ) {x}_{r} = {{\sum }_{r = 1}}^{R} ( {{\sum }_{n = 1}}^{N} {v}_{r}^{n} {q}_{r}^{n} ) {x}_{r}$$

The optimization of the phase adjustment factor q may be performed separately for each data layer r as follows:

$$( {q}_{r}^{1} , … , {q}_{r}^{N} ) = arg {min}_{\vert {q}_{r}^{n} \vert = 1} ( \vert {{\sum }_{n = 1}}^{N} {v}_{r}^{n} {q}_{r}^{n} \vert ) , r = 1 … R$$

With the eType2 codebook, the PMI with a rank R for each TRP is transmitted to the network in the form of two indices (i₁, i₂) (e.g., as defined in TS 38.214), from which the precoder for a number of sub-bands may be reconstructed by the network.

As shown in, e.g., Table 5.2.2.2.5-5 in TS 38.214, the precoder has a subscript t representing a sub-band index. In other words, the precoder is a function of frequency (or a function of sub-band index t). Accordingly, the optimal phase adjustment factor qⁿ may also be a function of frequency (or a function of sub-band index t) as well. The present disclosure proposes three solutions for incorporating or including the optimal phase adjustment factor qⁿ in the PMI and transmitting the same in the CSI feedback message to the network as follows.

### Solution 1:

In solution 1, the UE may determine a phase adjustment factor matrix Qⁿ, e.g.,

$${Q}^{n} = diag ( {q}^{n} ) = diag ( [ {q}_{1}^{n} , {q}_{2}^{n} , … , {q}_{R}^{N} ] ) ,$$

that is associated with all the sub-bands, where

$${q}_{l}^{n}$$

is the phase adjustment factor for data l from TRP n, the value of “l” ranges from 1 to R, and R is the rank indicated by the RI, which may range from 1 to 4 in some embodiments. In other words,

$${q}_{l}^{n}$$

is the phase adjustment factor associated with data layer/for the respective CSI-RS resource, which corresponds to TRP n.

In some embodiments, the UE may determine the matrix Qⁿ based on the UE's implementation. The matrix Qⁿ may work well for all the sub-bands, and the UE may incorporate it into the PMI which is to be reported to the network. It should be noted that the phase adjustment factors may be in other forms. For example, the UE may determine a set of phase adjustment factors, wherein the set includes

$$\{ {q}_{1}^{n} , {q}_{2}^{n} , … , {q}_{R}^{N} \} ;$$

or the UE may determine a number of phase adjustment factors, wherein the first is

$${q}_{1}^{n} ,$$

the second is

$${q}_{2}^{n} , … , the {R}^{th} is {q}_{R}^{n} .$$

According to some embodiments, the PMI for TRP n without incorporating the phase adjustment factors associated with TRP n may be reported as follows.

The key component of the PMI as shown in Table 5.2.2.2.5-5 in TS 38.214 is:

$${W}_{{q}_{1} {q}_{2} , {n}_{1} , {n}_{2} , {n}_{3 , l} , {p}_{l}^{( 1 )} , {p}_{l}^{( 2 )} , {i}_{2 , 5 , l} t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i + L , f}^{( 2 )} {φ}_{l , i + L , f}\end{matrix} ] , l = 1 , 2 , 3 , 4 ,$$

where the mappings from i₁ to q₁, q₂, n₁, n₂, n_{3,1}, n_{3,2}, n_{3,3}, n_{3,4}, and from i₂ to i_{2,5,1}, i_{2,5,2}, i_{2,5,3}, i_{2,5,4},

$${p}_{1}^{( 1 )} , {p}_{2}^{( 1 )} , {p}_{3}^{( 1 )} and {p}_{4}^{( 1 ) ,} , {p}_{1}^{( 2 )} , {p}_{2}^{( 2 )} , {p}_{3}^{( 2 )} and {p}_{4}^{( 2 )}$$

are as described in the 3GPP documents, such as TS 38.214, including the ranges of the constituent indices of i₁ and i₂.

For example, the PMI value corresponds to the codebook indices of i₁ and i₂ where

$${i}_{1} = \{ \begin{matrix}[ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1}\end{matrix} ] & v = 1 \\ [ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2}\end{matrix} ] & v = 2 \\ [ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3}\end{matrix} ] & v = 3 \\ [ \begin{matrix}{i}_{1 , 1} & {i}_{1 , 2} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 3} & {i}_{1 , 7 , 3} & {i}_{1 , 8 , 3} & {i}_{1 , 6 , 4} & {i}_{1 , 7 , 4} & {i}_{1 , 8 , 4}\end{matrix} ] & v = 4\end{matrix}$$

$${i}_{2} = \{ \begin{matrix}[ \begin{matrix}{i}_{2 , 3 , 1} & {i}_{2 , 4 , 1} & {i}_{2 , 5 , 1} ]\end{matrix} & v = 1 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2}\end{matrix} ] & v = 2 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3}\end{matrix} ] & v = 3 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3} & {i}_{2 , 2 , 4} & {i}_{2 , 4 , 4} & {i}_{2 , 5 , 4}\end{matrix} ] & v = 4\end{matrix}$$

The precoding matrices indicated by the PMI are determined from L+M_{ν} vectors.

L vectors, i.e.

$${v}_{{m}_{1}^{( i )} , {m}_{2}^{( i )}} ,$$

i=0, 1, . . . , L−1, are identified by the indices q₁, q₂, n₁, n₂, indicated by i_{1,1}, i_{1,2}, obtained as in section 5.2.2.2.3 of TS 38.214, where the values of C(x, y) are given in Table 5.2.2.2.5-4 in TS 38.214.

$${M}_{v} = ⌈ {p}_{v} \frac{{N}_{3}}{R} ⌉ vectors , {[ {y}_{0 , l}^{( f )} , {y}_{1 , l}^{( f )} , … , {y}_{{N}_{3} - 1 , l}^{( f )} ]}^{T} ,$$

f=0, 1, . . . , M_{ν}−1, are identified by Mᵢₙᵢₜᵢₐₗ (for N₃>19) and n_{3,l} (l=1, . . . , ν) where

$${M}_{initial} ∈ \{ - 2 {M}_{v} + 1 , - 2 {M}_{v} + 2 , … , 0 \}$$

$${n}_{3 , l} = [ {n}_{3 , l}^{( 0 )} , … , {n}_{3 , l}^{( {M}_{v} - 1 )} ]$$

$${n}_{3 , l}^{( f )} ∈ \{ 0 , 1 , … , {N}_{3} - 1 \}$$

which are indicated by means of the indices i_{1,5} (for N₃>19) and i_{1,6,l} (for M_{ν}>1 and l=1, . . . , ν), where

$${i}_{1 , 5} ∈ \{ 0 , 1 , … , 2 {M}_{v} - 1 \}$$

$${i}_{1 , 6 , l} ∈ \{ \begin{matrix}\begin{matrix}\{ 0 , 1 , … , ( \begin{matrix}{N}_{3} - 1 \\ {M}_{v} - 1\end{matrix} ) - 1 \} & {N}_{3} \leq 19\end{matrix} \\ \begin{matrix}\{ 0 , 1 , … , ( \begin{matrix}2 {M}_{v} - 1 \\ {M}_{v} - 1\end{matrix} ) - 1 \} & {N}_{3} > 19\end{matrix}\end{matrix}$$

The amplitude coefficient indicators i_{2,3,l} and i_{2,4,l} are

$${i}_{2 , 3 , l} = [ \begin{matrix}{k}_{l , 0}^{( 1 )} & {k}_{l , 1}^{( 1 )}\end{matrix} ]$$

$${i}_{2 , 4 , l} = [ {k}_{l , 0}^{( 2 )} … {k}_{l , {M}_{v} - 1}^{( 2 )} ]$$

$${k}_{l , f}^{( 2 )} = [ {k}_{l , 0 , f}^{( 2 )} … {k}_{l , 2 L - 1 , f}^{( 2 )} ]$$

$${k}_{l , p}^{( 1 )} ∈ \{ 1 , … , 15 \}$$

$${k}_{l , i , f}^{( 2 )} ∈ \{ 0 , … , 7 \}$$

for l=1, . . . , ν.

The phase coefficient indicator i_{2,5,l} is

$${i}_{2 , 5 , l} = [ {c}_{l , 0} … {c}_{l , {M}_{v} - 1} ]$$

$${c}_{l , f} = [ {c}_{l , 0 , f} … {c}_{l , 2 L - 1 , f} ]$$

$${c}_{l , i , f} ∈ \{ 0 , … , 15 \}$$

for l=1, . . . , ν.

Let K₀=[β2LM₁]. The bitmap whose nonzero bits identify which coefficients in i_{2,4,l} and i_{2,5,l} are reported, is indicated by i_{1,7,l}:

$${i}_{1 , 7 , l} = [ {k}_{l , 0}^{( 3 )} … {k}_{l , {M}_{v} - 1}^{( 3 )} ]$$

$${k}_{l , f}^{( 3 )} = [ {k}_{l , 0 , f}^{( 3 )} … {k}_{l , 2 L - 1 , f}^{( 3 )} ]$$

$${k}_{l , i , f}^{( 3 )} ∈ \{ 0 , 1 \}$$

for l=1, . . . , ν, such that

$${K}_{l}^{NZ} = {\sum }_{i = 0}^{2 L - 1} {\sum }_{f = 0}^{{M}_{v} - 1} {k}_{l , i , f}^{( 3 )} \leq {K}_{0}$$

is the number of nonzero coefficients for layer l=1, . . . , ν and

$${K}^{NZ} = {\sum }_{l = 1}^{v} {K}_{l}^{NZ} \leq 2 {K}_{0}$$

is the total number of nonzero coefficients.

The indices of i_{2,4,l}, i_{2,5,l} and i_{1,7,l} are associated to the M_{ν} codebook indices in n_{3,l}.

The mapping from

$${k}_{l , p}^{( 1 )}$$

to the amplitude coefficient

$${p}_{l , p}^{( 1 )}$$

is given in Table 5.2.2.2.5-2 (copied below) and the mapping from

$${k}_{l , i , f}^{( 2 )}$$

to the amplitude coefficient

$${P}_{l , i , f}^{( 2 )}$$

coefficients are represented by

$${p}_{l}^{( 1 )} = [ \begin{matrix}{p}_{l , 0}^{( 1 )} & {p}_{l , 1}^{( 1 )}\end{matrix} ]$$

$${p}_{l}^{( 2 )} = [ {p}_{l , 0}^{( 2 )} … {p}_{l , {M}_{υ} - 1}^{( 1 )} ]$$

$${p}_{l , f}^{( 2 )} = [ {p}_{l , 0 , f}^{( 2 )} … {p}_{l , 2 L - 1 , f}^{( 2 )} ]$$

for l=1, . . . , ν.

Let

$${f}_{l}^{*} ∈ \{ 0 , 1 , … , {M}_{υ} - 1 \}$$

be the index of i_{2,4,l} and

$${i}_{l}^{*} ∈ \{ 0 , 1 , … , 2 L - 1 \}$$

be the index of

$${k}_{l , {f}_{l}^{*}}^{( 2 )}$$

which identify the strongest coefficient of layer l, i.e., the element

$${k}_{l , {i}_{l}^{*} , {f}_{l}^{*}}^{( 2 )}$$

of i_{2,4,l}, for l=1, . . . , ν. The codebook indices of n_{3,l} are remapped with respect to

$${n}_{3 , l}^{( {f}_{l}^{*} )} as {n}_{3 , l}^{( f )} = ( {n}_{3 , l}^{( f )} - {n}_{3 , l}^{( {f}_{l}^{*} )} ) mod {N}_{3} ,$$

such that

$${n}_{3 , l}^{( {f}_{l}^{*} )} = 0 ,$$

after remapping. The index f is remapped with respect to

$${f}_{l}^{*}$$

as

$$f = ( f - {f}_{l}^{*} ) mod {M}_{υ} ,$$

such that the index of the strongest coefficient is

$${f}_{l}^{*} = 0$$

(l=1, . . . , ν), after remapping. The indices of i_{2,4,l}, i_{2,5,l} and i_{1,7,l} indicate amplitude coefficients, phase coefficients and bitmap after remapping.

The strongest coefficient of layer l is identified by i_{1,8,l}∈{0, 1, . . . , 2L−1}, which is obtained as follows:

$${i}_{1 , 8 , l} = \{ \begin{matrix}{\sum }_{i = 0}^{{i}_{1}^{*}} {k}_{1 , i , 0}^{( 3 )} - 1 & υ = 1 \\ {i}_{l}^{*} & 1 < υ \leq \end{matrix}$$

for l=1, . . . , ν.

TABLE 5.2.2.2.5-2
$Mapping of elements of {i}_{2 , 3 , l} : {k}_{l , p}^{( 1 )} to {p}_{l , p}^{( 1 )}$

| ${k}_{l , p}^{( 1 )}$ | ${p}_{l , p}^{( 1 )}$ |
|---|---|
| 0 | Reserved |
| 1 | $\frac{1}{\sqrt{128}}$ |
| 2 | ${( \frac{1}{8192} )}^{1 / 4}$ |
| 3 | $\frac{1}{8}$ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | $\frac{1}{4}$ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | $\frac{1}{2}$ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

The amplitude and phase coefficient indicators are reported as follows:

$${k}_{l , ⌊ \frac{{i}_{l}^{*}}{L} ⌋}^{( 1 )} = 15 , {k}_{l , {i}_{l}^{*} , 0}^{( 2 )} = 7 , {k}_{l , {i}_{l}^{*} , 0}^{( 3 )} = 1 and {c}_{l , {i}_{l}^{*} , 0} = 0 ( l = 1 , … , υ ) .$$

The indicators

$${k}_{l , ⌊ \frac{{i}_{l}^{*}}{L} ⌋}^{( 1 )} , {k}_{l , {i}_{l}^{*} , 0}^{( 2 )} and {c}_{l , {i}_{l}^{*} , 0}$$

are not reported for I=1, . . . , ν.
The indicator

$${k}_{l , ( ⌊ \frac{{i}_{l}^{*}}{L} ⌋ + ) mod 2}^{( 1 )}$$

is reported for l=1, . . . , ν.
The K^{NZ}−ν indicators

$${k}_{l , i , f}^{( 2 )}$$

for which

$${k}_{l , i , f}^{( 3 )} = 1 ,$$

i≠iₗ*, f≠0 are reported.
The K^{NZ}−ν indicators c_{l,i,f} for which

$${k}_{l , i , f}^{( 3 )} = 1 , i \neq {i}_{l}^{*} , f \neq 0$$

are reported.
The remaining 2L·M_{ν}·V−K^{NZ} indicators

$${k}_{l , i , f}^{( 2 )}$$

are not reported.
The remaining 2L·M_{ν}·ν−K^{NZ} indicators c_{l,i,f} are not reported.

TABLE 5.2.2.2.5-3
$Mapping of elements of {i}_{2 , 4 , l} : {k}_{l , i , f}^{( 2 )} to {p}_{l , i , f}^{( 2 )}$

| ${k}_{l , i , f}^{( 2 )}$ | ${p}_{l , i , f}^{( 2 )}$ |
|---|---|
| 0 | $\frac{1}{8 \sqrt{2}}$ |
| 1 | $\frac{1}{8}$ |
| 2 | $\frac{1}{4 \sqrt{2}}$ |
| 3 | $\frac{1}{4}$ |
| 4 | $\frac{1}{2 \sqrt{2}}$ |
| 5 | $\frac{1}{2}$ |
| 6 | $\frac{1}{\sqrt{2}}$ |
| 7 | 1 |

The elements of n₁ and n₂ are found from i_{1,2} using the algorithm described in section 5.2.2.2.3 of TS 38.214, where the values of C(x, y) are given in Table 5.2.2.2.5-4 (copied below) in TS 38.214.

For N₃>19, Mᵢₙᵢₜᵢₐₗ is identified by i_{1,5}.

For all values of N₃,

$${n}_{3 , l}^{( 0 )} = 0$$

for l=1, . . . , ν. If M_{ν}>1, the nonzero elements of n_{3,l}, identified by

$${n}_{3 , l}^{( 1 )} , … , {n}_{3 , l}^{( {M}_{v} - 1 )} ,$$

are found from i_{1,6,l} (l=1, . . . , ν), for N₃≤19, and from i_{1,6,l} (l=1, . . . , ν) and Mᵢₙᵢₜᵢₐₗ, for N₃>19, using C(x,y) as defined in Table 5.2.2.2.5-4 in TS 38.214 and the algorithm as follows:

### S₀=0

for f=1, . . . , M_{ν}−1
Find the largest x*∈{M_{ν}−1−f, . . . , N₃−1−f} in Table 5.2.2.2.5-4 such that

i_{1,6,l} − s_{f-1} ≥ C(x*, M_{υ} − f)
e_{f} = C(x*, M_{υ} − f)
s_{f} = s_{f-1} + e_{f}
if N₃ ≤ 19
${n}_{3 , l}^{( f )} = {N}_{3} - 1 - x *$
else
${n}_{l}^{( f )} = 2 {M}_{υ} - 1 - x *$
$if {n}_{l}^{( f )} \leq {M}_{initial} + 2 {M}_{υ} - 1$
${n}_{3 , l}^{( f )} = {n}_{l}^{( f )}$
else
${n}_{3 , l}^{( f )} = {n}_{l}^{( f )} + ( {N}_{3} - 2 {M}_{υ} )$
end if
end if

TABLE 5.2.2.2.5-4
Combinatorial coefficients C(x, y)

| | y | | | | | | | | |
|---|---|---|---|---|---|---|---|---|---|
| x | 1 | 2 | 3 | 4 | 5 | 6 | 7 | 8 | 9 |
| 0 | 0 | 0 | 0 | 0 | 0 | 0 | 0 | 0 | 0 |
| 1 | 1 | 0 | 0 | 0 | 0 | 0 | 0 | 0 | 0 |
| 2 | 2 | 1 | 0 | 0 | 0 | 0 | 0 | 0 | 0 |
| 3 | 3 | 3 | 1 | 0 | 0 | 0 | 0 | 0 | 0 |
| 4 | 4 | 6 | 4 | 1 | 0 | 0 | 0 | 0 | 0 |
| 5 | 5 | 10 | 10 | 5 | 1 | 0 | 0 | 0 | 0 |
| 6 | 6 | 15 | 20 | 15 | 6 | 1 | 0 | 0 | 0 |
| 7 | 7 | 21 | 35 | 35 | 21 | 7 | 1 | 0 | 0 |
| 8 | 8 | 28 | 56 | 70 | 56 | 28 | 8 | 1 | 0 |
| 9 | 9 | 36 | 84 | 126 | 126 | 84 | 36 | 9 | 1 |
| 10 | 10 | 45 | 120 | 210 | 252 | 210 | 120 | 45 | 10 |
| 11 | 11 | 55 | 165 | 330 | 462 | 462 | 330 | 165 | 55 |
| 12 | 12 | 66 | 220 | 495 | 792 | 924 | 792 | 495 | 220 |
| 13 | 13 | 78 | 286 | 715 | 1287 | 1716 | 1716 | 1287 | 715 |
| 14 | 14 | 91 | 364 | 1001 | 2002 | 3003 | 3432 | 3003 | 2002 |
| 15 | 15 | 105 | 455 | 1365 | 3003 | 5005 | 6435 | 6435 | 5005 |
| 16 | 16 | 120 | 560 | 1820 | 4368 | 8008 | 11440 | 12870 | 11440 |
| 17 | 17 | 136 | 680 | 2380 | 6188 | 12376 | 19448 | 24310 | 24310 |
| 18 | 18 | 153 | 816 | 3060 | 8568 | 18564 | 31824 | 43758 | 48620 |

When n_{3,l} and Mᵢₙᵢₜᵢₐₗ are known. i_{1,5} and i_{1,6,l} (l=1, . . . , ν) are found as follows:
If N₃≤19. i_{1,5}=0 and is not reported. If M_{ν}=1. i_{1,6,l}=0, for l=1, . . . , ν, and is not reported. If M_{ν}>1,

$${i}_{1 , 6 , l} = {\sum }_{f = 1}^{{M}_{υ} - 1} C ( {N}_{3} - 1 - {n}_{3 , l}^{( f )} , {M}_{υ} - f ) ,$$

where C(x, y) is given in Table 5.2.2.2.5-4 and where the indices f=1, . . . , M_{ν}−1 are assigned such that

$${n}_{3 , l}^{( f )}$$

increases as f increases.
If N₃>19, Mᵢₙᵢₜᵢₐₗ is indicated by i_{1,5}, which is reported and given by

$${i}_{1 , 5} = \{ \begin{matrix}{M}_{initial} & {M}_{initial} = 0 \\ {M}_{initial} + 2 {M}_{υ} & {M}_{initial} < 0\end{matrix}$$

Only the nonzero indices

$${n}_{3 , l}^{( f )} ∈ IntS ,$$

where IntS={(Mᵢₙᵢₜᵢₐₗ+i) mod N₃, i=0, 1, . . . , 2M_{ν}−1}, are reported, where the indices f=1, . . . , M_{ν}−1 are assigned such that

$${n}_{3 , l}^{( f )}$$

increases as f increases. Let

$${n}_{l}^{( f )} = \{ \begin{matrix}{n}_{3 , l}^{( f )} & {n}_{3 , l}^{( f )} \leq {M}_{initial} + 2 {M}_{υ} - 1 \\ {n}_{3 , l}^{( f )} - ( {N}_{3} - 2 {M}_{υ} ) & {n}_{3 , l}^{( f )} > {M}_{initial} + {N}_{3} - 1\end{matrix} , then {i}_{1 , 6 , l} = {\sum }_{f = 1}^{{M}_{υ} - 1} C ( 2 {M}_{υ} - 1 - {n}_{l}^{( f )} , {M}_{υ} - f ) ,$$

where C(x, y) is given in Table 5.2.2.2.5-4.

The codebooks for 1-4 layers are given in Table 5.2.2.2.5-5 in TS 38.214, where

$${m}_{1}^{( i )} , {m}_{2}^{( i )} ,$$

for l=0, 1, . . . , L−1,

$${v}_{{m}_{1}^{( i )} , {m}_{2}^{( i )}}$$

are obtained as in section 5.2.2.2.3 of TS 38.214, and the quantities φ_{l,i,f} and y_{t,l} are given by

$${φ}_{l , i , f} = {e}^{j \frac{2 π {c}_{l , i , f}}{16}}$$

$${y}_{t , l} = [ \begin{matrix}{y}_{t , l}^{( 0 )} & {y}_{t , l}^{( 1 )} & ⋯ & {y}_{t , l}^{( {M}_{υ} - 1 )}\end{matrix} ]$$

where t={0,1, . . . , N₃−1}, is the index associated with the precoding matrix, l={1, . . . , ν}, and with

$${y}_{t , l}^{( f )} = {e}^{j \frac{2 π {tn}_{3 , l}^{( f )}}{{N}_{3}}}$$

for f=0, 1, . . . , M_{ν}−1.

Based on the above,

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l ,} t}^{l}$$

can be determined and reported to the network.

To incorporate the optimal phase adjustment factors associated with TRP n into the PMI for TPR n, in some embodiments,

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l ,} t}^{l}$$

may be multiplied by the corresponding phase adjustment factor

$${q}_{l}^{n}$$

as follows:

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l ,} t}^{l} {q}_{l}^{n} =$$

$$\frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} {q}_{l}^{n} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f} {q}_{l}^{n}\end{matrix} ] , l = 1 , 2 , 3 , 4.$$

The phase adjustment factor

$${q}_{l}^{n} = {e}^{j {ϕ}_{l}^{n}}$$

for data layer l may be multiplied together with the phase offset ϕ_{l,i,f} to form a single combined factor, e.g.,

$${φ}_{l , i , f} {q}_{l}^{n} = {e}^{{jc}_{l , i , f}} {e}^{j {ϕ}_{l}^{n}}$$

In some embodiments, the combined factor may be indicated in the PMI feedback message. For example, when a 16PSK is applied, let

$${c}_{l , i , f}^{′} = mod ( {c}_{l , i , f} + round ( \frac{16 ( {ϕ}_{l}^{n} )}{2 π} ) , 16 ) .$$

By sending

$${c}_{l , i , f}^{′}$$

in the place of c_{l,i,f} in the PMI feedback message, the per-layer phase adjustment factor

$${q}_{l}^{n}$$

is sent back to the network as a part of eType2 PMI.

It should be noted that the phase for all the delay taps, including the strongest one

$$( i . e . , {c}_{l , {i}_{l}^{*} , 0} ) ,$$

may be reported to the network. In other words, the phase of the strongest frequency domain component of each data layer is reported to the BS.

In conclusion, in solution 1, the UE may incorporate a phase adjustment factor associated with a data layer for a respective TRP and associated with all sub-bands in the PMI for the respective TRP to be reported in the CSI feedback message transmitted to the network.

### Solution 2:

In solution 2, the UE may determine a phase adjustment factor matric

$${Q}_{t}^{n} ,$$

e.g.,

$${Q}_{t}^{n} = diag ( {q}_{t}^{n} ) = diag ( [ {q}_{1 , t}^{n} , {q}_{2 , t}^{n} , … , {q}_{R , t}^{n} ] ) ,$$

that is associated with a respective sub-band t, where

$${q}_{l , t}^{n}$$

is the phase adjustment factor for data layer l from TRP n and for sub-band t, the value of “l” ranges from 1 to R, and R is the rank indicated by the RI, which may be range from 1 to 4 in some embodiments. The phase adjustment factor matrix

$${Q}_{t}^{n}$$

may work best for each sub-band t, and the UE may incorporate it into the PMI which is to be reported to the network. It should be noted that the phase adjustment factors may be in other forms. For example, for each sub-band t and for each data layer l, the UE may determine a set of phase adjustment factors, wherein the set includes

$$\{ {q}_{l , t}^{1} , {q}_{l , t}^{2} , … , {q}_{l , t}^{N} \} ;$$

or the UE may determine a number of phase adjustment factors, wherein the first is

$${q}_{l , t}^{1} ,$$

the second is

$${q}_{l , t}^{2} , … ,$$

### and the N^{th} is

$${q}_{l , t}^{N} .$$

For sub-band t, the optimal phase adjustment factors may be determined as follows:

$$( {q}_{r , t}^{1} , … , {q}_{r , t}^{N} ) = arg {max}_{\vert {q}_{r , t}^{n} \vert = 1} ( \vert {\sum }_{n = 1}^{N} {v}_{r , t}^{n} {q}_{r , t}^{n} \vert ) , r = 1 … R$$

$$where$$

$${a}_{n , t} {H}_{n , t} {W}_{n , t} = {V}_{t}^{n} = [ {v}_{1 , t}^{n} , … , {v}_{R , t}^{n} ]$$

Where a_{n,t} is the amplitude adjustment factor, H_{n,t} is the channel matrix, and W_{n,t} is the precoding matrix of TRP n in sub-band t.

The present disclosure proposes to incorporate the sub-band dependent phase adjustment factors into the eType 2 PMI. To incorporate the optimal phase adjustment factors associated with TRP n into the PMI for TRP n, in some embodiments,

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l} , t}^{l}$$

may be multiplied by the corresponding phase adjustment factor

$${W}_{{q}_{1} , {q}_{2} , {n}_{1} , {n}_{2} , {n}_{3 , l} , {p}_{l}^{( 1 )} , {p}_{l}^{( 2 )} , {i}_{2 , 5 , l} , t}^{l} {q}_{l , t}^{n} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} {q}_{l , t}^{n} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f} {q}_{l , t}^{n}\end{matrix} ] ,$$

$$l = 1 , 2 , 3 , 4$$

as follows:

$${q}_{l , t}^{n}$$

The term

$${\sum }_{f = 0}^{{M}_{υ} - 1} {y}_{t , l}^{( f )} {p}_{l , i , f}^{( 2 )} {φ}_{l , i , f} {q}_{l , t}^{n}$$

is the summation of the terms indicated by bitmaps in the PMI component i₁. For ease of notation, let

$${y}_{t , l}^{′ ( f )} , {p}_{l , i , f}^{′ ( 2 )} ,$$

φ′_{l,i,f} be these terms with their natural index f. For those terms not indicated by the bitmap, their

$${P}_{l , i , f}^{( 2 )}$$

are taken as 0. Then

$${\sum }_{f = 0}^{{M}_{υ} - 1} {y}_{t , l}^{( f )} {p}_{l , i , f}^{( 2 )} {φ}_{l , i , f} {q}_{l , t}^{n}$$

may be transformed as follows:

$${\sum }_{f = 0}^{{M}_{υ} - 1} {y}_{t , l}^{( f )} {p}_{l , i , f}^{( 2 )} {φ}_{l , i , f} {q}_{l , t}^{n} = {\sum }_{f = 0}^{{N}_{3} - 1} {y}_{t , l}^{′ ( f )} {p}_{l , i , f}^{′ ( 2 )} {φ}_{l , i , f}^{′} {q}_{l , t}^{n} = {\sum }_{f = 0}^{{N}_{3} - 1} {e}^{j \frac{2 π tf}{{N}_{3}}} {p}_{l , i , f}^{′ ( 2 )} {φ}_{l , i , f}^{′} {q}_{l , t}^{n}$$

The term

$${\sum }_{f = 0}^{{N}_{3} - 1} {e}^{j \frac{2 π tf}{{N}_{3}}} {p}_{l , i , f}^{′ ( 2 )} {φ}_{l , i , f}^{′} {q}_{l , t}^{n}$$

is the inverse discrete Fourier transform (IDFT) of the sequence

$${P}_{l , i}^{( 2 )} = [ {p}_{l , i , 1}^{′ ( 2 )} {φ}_{l , i , 1}^{′} , … , {p}_{l , i , 1}^{′ ( 2 )} {φ}_{l , i , 1}^{′} ] ( i . e . , ID FT ( {P}_{l , i}^{( 2 )} ) ) .$$

$$\begin{matrix}{\sum }_{f = 0}^{{N}_{3} - 1} {e}^{j \frac{2 π tf}{{N}_{3}}} {p}_{l , i , f}^{′ ( 2 )} {φ}_{l , i , f}^{′} {q}_{l , t}^{n} = IDFT ( {P}_{l , i}^{( 2 )} ) ° {q}_{l}^{n} = IDFT ( {P}_{l , i}^{( 2 )} ) ° IDFT ( DFT ( {q}_{l}^{n} ) ) \\ = IDFT ( {P}_{l , i}^{( 2 )} ⊗ ( DFT ( {q}_{l}^{n} ) ) ) = IDFT ( {W}_{l , i}^{n} )\end{matrix}$$

$$where$$

$${W}_{l , i}^{n} = DFT ( IDFT ( {P}_{l , i}^{( 2 )} ) ° {q}_{l}^{n} ) = {P}_{l , i}^{( 2 )} ⊗ DFT ( {q}_{l}^{n} )$$

$$\begin{matrix}{\sum }_{f = 0}^{{N}_{3} - 1} {e}^{j \frac{2 π tf}{{N}_{3}}} {p}_{l , i , f}^{′ ( 2 )} {φ}_{l , i , f}^{′} {q}_{l , t}^{n} = {\sum }_{f = 0}^{{N}_{3} - 1} {e}^{j \frac{2 π tf}{{N}_{3}}} {p}_{l , i , f}^{′ ( 2 )} {φ}_{l , i , f}^{′} ( {\sum }_{f = 0}^{{N}_{3} - 1} {e}^{j \frac{2 π tf}{{N}_{3}}} ( {\sum }_{τ = 0}^{{N}_{3} - 1} {e}^{j \frac{- 2 π τ f}{{N}_{3}}} {q}_{l , τ}^{n} ) ) \\ = {\sum }_{f = 0}^{{N}_{3} - 1} {e}^{j \frac{2 π tf}{{N}_{3}}} {p}_{l , i , f}^{′ ( 2 )} {φ}_{l , i , f}^{′} ( {\sum }_{f = 0}^{{N}_{3} - 1} {e}^{j \frac{2 π tf}{{N}_{3}}} ( {Q}_{l , f}^{n} ) ) \\ = {\sum }_{f = 0}^{{N}_{3} - 1} {e}^{j \frac{2 π tf}{{N}_{3}}} ( {\sum }_{g = 0}^{{N}_{3} - 1} {p}_{l , i , f - g}^{′ ( 2 )} {φ}_{l , i , f - g}^{′} {Q}_{l , g}^{n} )\end{matrix}$$

$$where$$

$${\sum }_{τ = 0}^{{N}_{3} - 1} {e}^{j \frac{- 2 π τ f}{{N}_{3}}} {q}_{l , τ}^{n} = {Q}_{l , f}^{n} , {\sum }_{g = 0}^{{N}_{3} - 1} {p}_{l , i , f - g}^{′ ( 2 )} {φ}_{l , i , f - g}^{′} {Q}_{l , g}^{n} = {W}_{l , i , f}^{n}$$

In short notation,

$$IDFT ( {P}_{l , i}^{( 2 )} ) ° IDFT ( DFT ( {q}_{l}^{n} ) ) = IDFT ( {P}_{l , i}^{( 2 )} ⊗ ( DFT ( {q}_{l}^{n} ) ) ) = IDFT ( {W}_{l , i}^{n} )$$

wherein the operator “°” represents a Hadamard (element-wise) product, and the operator “⊗” represents a convolution operation.

Accordingly, in some embodiments,

$${W}_{l , i}^{n}$$

may be ted back as a part of eType 2 PMI feedback in the place of

$${p}_{l , i , f}^{′ ( 2 )} {φ}_{l , i , f}^{′} .$$

### That is,

$${p}_{l , i , f}^{′′ ( 2 )} = \vert {W}_{l , i , f}^{n} \vert ,$$

and

$${φ}_{l , i , f}^{′′} = \frac{{W}_{l , i , f}^{n}}{\vert {W}_{l , i , f}^{n} \vert} , and {p}_{l , i , f}^{′′ ( 2 )}$$

and φ″_{l,i,f} are encoded in the place of

$${p}_{l , i , f}^{′ ( 2 )}$$

and φ′_{l,i,f}. In the encoding of

$${p}_{l , i , f}^{′′ ( 2 )}$$

and φ″_{l,i,f}, the bitmap indicator “i” and “l” may be updated to reflect the new non-zero terms in

$${p}_{l , i , f}^{′′ ( 2 )} .$$

It should be noted that the phase for all the delay taps, including the strongest one

$$( i . e . , {c}_{l , {i}_{l}^{*} , 0} ) ,$$

may be reported to the network. In other words, the phase of the strongest frequency domain component of each data layer is reported to the BS.

In conclusion, in solution 2, the UE may incorporate a phase adjustment factor associated with a data layer for a respective TRP and associated with a respective sub-band in the PMI for the respective TRP to be reported in the CSI feedback message transmitted to the network.

### Solution 3:

In solution 3, the UE may include the phase adjustment factors as an additional part in the PMI as part of the CSI feedback message, and transmit the CSI feedback message to the network. In some embodiments, each of the phase adjustment factors

$$( e . g . , {q}_{l}^{n} )$$

is associated with a data layer for a respective TRP and associated with all sub-bands. In some other embodiments, each of the phase adjustment factors

$$( e . g . , {q}_{l , t}^{n} )$$

is associated with a data layer for a respective TRP and associated with a respective sub-band.

For example, each phase adjustment factor

$${q}_{r , t}^{n}$$

may be quantized, such as using 16PSK, as follows:

$${d}_{n , r , t} = round ( \frac{16 angle ( {q}_{r , t}^{n} )}{2 π} )$$

Solution 3 is straightforward and does not change the eType 2 codebook, e.g., the way in which

$${W}_{n} = {W}_{1 , n} {\tilde{W}}_{2 , n} {W}_{f , n}^{H}$$

or the indices (i₁, i₂) are computed.

According to some embodiments of the present disclosure, each PMI included in the CSI feedback message may, additionally or alternatively, include an amplitude adjustment factor (e.g., an) for a codeword associated with a respective CSI-RS resource or a respective TRP (e.g., TRP n). The amplitude adjustment factors may be determined based on the UE's implementation.

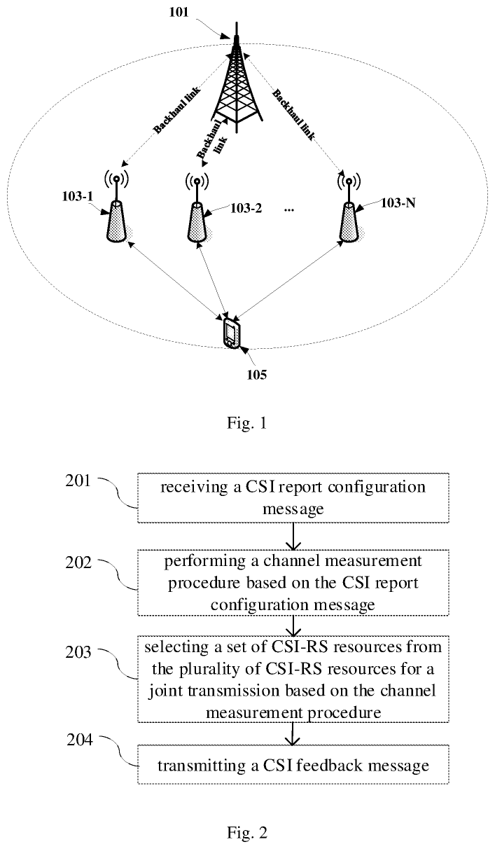

FIG. 2 illustrates an exemplary method performed by a UE for transmitting a CSI feedback message according to some embodiments of the present disclosure. It is contemplated that the method may also be performed by other devices with similar functions.

In operation 201, the UE may receive a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports. In operation 202, the UE may perform a channel measurement procedure based on the CSI report configuration message. In operation 203, the UE may select a set of CSI-RS resources from the plurality of CSI-RS resources for a joint transmission based on the channel measurement procedure. In operation 204, the UE may transmit a CSI feedback message after the channel measurement procedure is performed, wherein the CSI feedback message includes a single RI, a single CQI, and a set of PMIs, wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

According to some embodiments, each PMI of the set of PMIs is based on an eType 2 codebook, and may incorporate or include a number of phase adjustment factors, wherein a total number of the phase adjustment factors equals a value of the RI, and each phase adjustment factor is associated with a data layer for the respective CSI-RS resource. For example, the phase adjustment factors may be incorporated or included in the PMI in a manner in accordance with any of solutions 1-3 as described above. In an embodiment, each phase adjustment factor is associated with all sub-bands. In another embodiment, each phase adjustment factor is associated with a respective sub-band. Additionally or alternatively, each PMI of the set of PMIs may include an amplitude adjustment factor for a codeword associated with the respective CSI-RS resource.

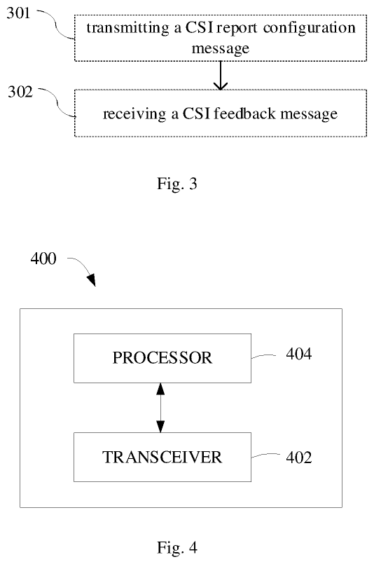

FIG. 3 illustrates an exemplary method performed by a BS according to some embodiments of the present disclosure. It is contemplated that the method may also be performed by other devices with similar functions.

In operation 301, the BS may transmit a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports. In operation 302, the BS may receive a CSI feedback message including a single RI, a single CQI, and a set of PMIs, wherein each PMI of the set of PMIs is associated with a respective CSI-RS resource in a subset of the plurality of CSI-RS resources, and wherein the RI indicates a rank applied to each CSI-RS resource of the subset of the plurality of CSI-RS resources, and the CQI indicates a channel quality associated with all CSI-RS resources in the subset of the plurality of CSI-RS resources.

According to some embodiments, each PMI of the set of PMIs is based on an eType 2 codebook, and may incorporate or include a number of phase adjustment factors, wherein a total number of the phase adjustment factors equals a value of the RI, and each phase adjustment factor is associated with a data layer for the respective CSI-RS resource. For example, the phase adjustment factors may be incorporated or included in the PMI in a manner in accordance with any of solutions 1-3 as described above. In an embodiment, each phase adjustment factor is associated with all sub-bands. In another embodiment, each phase adjustment factor is associated with a respective sub-band. Additionally or alternatively, each PMI of the set of PMIs may include an amplitude adjustment factor for a codeword associated with the respective CSI-RS resource.

FIG. 4 illustrates a simplified block diagram of an exemplary apparatus 400 according to some embodiments of the present disclosure.

As shown in FIG. 4, an example of the apparatus 400 may include at least one processor 404 and at least one transceiver 402 coupled to the processor 404. The apparatus 400 may be a UE, a BS, or any other device with similar functions.

Although in this figure, elements such as the transceiver 402 and the processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations of the UE as described with respect to any of FIGS. 1-3. For example, the transceiver 402 may be configured to receive a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports; the processor 404 may be configured to perform a channel measurement procedure based on the CSI report configuration message, and select a set of CSI-RS resources from the plurality of CSI-RS resources for a joint transmission based on the channel measurement procedure; and the transceiver 402 may be further configured to transmit a CSI feedback message after the channel measurement procedure is performed, wherein the CSI feedback message includes a single RI, a single CQI, and a set of PMIs, wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

In some embodiments of the present disclosure, the apparatus 400 may be a BS. The transceiver 402 and the processor 404 may interact with each other so as to perform the operations of the BS as described with respect to any of FIGS. 1-3. For example, the transceiver 402 may be configured to transmit a CSI report configuration message indicating a plurality of CSI-RS resources for channel measurement and at least one zero-power or non-zero power CSI-RS resource for interference measurement, wherein each CSI-RS resource of the plurality of CSI-RS resources is associated with a CRI and an identical number of CSI-RS ports; and the transceiver 402 may be further configured to receive a CSI feedback message including a single RI, a single CQI, and a set of PMIs, wherein each PMI of the set of PMIs is associated with a respective CSI-RS resource in a subset of the plurality of CSI-RS resources, and wherein the RI indicates a rank applied to each CSI-RS resource of the subset of the plurality of CSI-RS resources, and the CQI indicates a channel quality associated with all CSI-RS resources in the subset of the plurality of CSI-RS resources.

In some embodiments of the present disclosure, the apparatus 400 may further include at least one non-transitory computer-readable medium.

For example, in some embodiments of the present disclosure, the non-transitory computer-readable medium may have stored thereon computer-executable instructions to cause the processor 404 to implement the method performed by a UE as described above. For example, the computer-executable instructions, when executed, cause the processor 404 interacting with the transceiver 402 to perform the operations of the UE as described with respect to any of FIGS. 1-3.

In some embodiments of the present disclosure, the non-transitory computer-readable medium may have stored thereon computer-executable instructions to cause the processor 404 to implement the method performed by a BS as described above. For example, the computer-executable instructions, when executed, cause the processor 404 interacting with the transceiver 402 to perform the operations of the BS as described with respect to any of FIGS. 1-3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a channel state information (CSI) report configuration message indicating a plurality of channel state information reference signal (CSI-RS) resources for channel measurement and at least one zero-power or non-zero power CSI-RS resource for interference measurement, wherein each CSI-RS resource of the plurality of CSI-RS resources is associated with a CSI-RS resource indicator (CRI) and an identical number of CSI-RS ports;
perform a channel measurement procedure based on the CSI report configuration message;
select a set of CSI-RS resources from the plurality of CSI-RS resources for a joint transmission based on the channel measurement procedure; and
transmit a CSI feedback message after the channel measurement procedure is performed, wherein the CSI feedback message includes a single rank indicator (RI), a single channel quality indicator (CQI), and a set of precoding matrix indicators (PMIs), wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

2. The UE of claim 1, wherein each PMI of the set of PMIs is based on an eType 2 codebook, and includes a phase of a strongest frequency domain component of each data layer.

3. The UE of claim 2, wherein each PMI of the set of PMIs incorporates a number of phase adjustment factors, a total number of the phase adjustment factors equals a value of the RI, and each phase adjustment factor is associated with a data layer for the respective CSI-RS resource.

4. The UE of claim 3, wherein each phase adjustment factor is associated with all sub-bands.

5. The UE of claim 3, wherein each phase adjustment factor is associated with a respective sub-band.

6. The UE of claim 1, wherein each PMI of the set of PMIs is based on an eType 2 codebook and includes a number of phase adjustment factors, a total number of the phase adjustment factors equals a value of the RI, and each phase adjustment factor is associated with a data layer for the respective CSI-RS resource.

7. The UE of claim 6, wherein each phase adjustment factor is associated with a respective sub-band.

8. The UE of claim 6, wherein each phase adjustment factor is associated with all sub-bands.

9. The UE of claim 1, wherein each PMI of the set of PMIs includes an amplitude adjustment factor for a codeword associated with the respective CSI-RS resource.

10. A base station, comprising:
at least one memory; and
at least one processor coupled with the at least one memory and configured to cause the base station to:
transmit a channel state information (CSI) report configuration message indicating a plurality of channel state information reference signal (CSI-RS) resources for channel measurement and at least one zero-power or non-zero power CSI-RS resource for interference measurement, wherein each CSI-RS resource of the plurality of CSI-RS resources is associated with a CSI-RS resource indicator (CRI) and an identical number of CSI-RS ports; and
receive a CSI feedback message including a single rank indicator (RI), a single channel quality indicator (CQI), and a set of precoding matrix indicators (PMIs), wherein each PMI of the set of PMIs is associated with a respective CSI-RS resource in a subset of the plurality of CSI-RS resources, and wherein the RI indicates a rank applied to each CSI-RS resource of the subset of the plurality of CSI-RS resources, and the CQI indicates a channel quality associated with all CSI-RS resources in the subset of the plurality of CSI-RS resources.

11. The base station of claim 10, wherein each PMI of the set of PMIs is based on an eType 2 codebook, and includes a phase of a strongest frequency domain component of each data layer.

12. The base station of claim 11, wherein each PMI of the set of PMIs incorporates a number of phase adjustment factors, a total number of the phase adjustment factors equals a value of the RI, and each phase adjustment factor is associated with a data layer for the respective CSI-RS resource.

13. The base station of claim 10, wherein each PMI of the set of PMIs is based on an eType 2 codebook and includes a number of phase adjustment factors, a total number of the phase adjustment factors equals a value of the RI, and each phase adjustment factor is associated with a data layer for the respective CSI-RS resource.

14. The base station of claim 10, wherein each PMI of the set of PMIs includes an amplitude adjustment factor for a codeword associated with the respective CSI-RS resource.

15. A method performed by a user equipment (UE), the method comprising:
receiving a channel state information (CSI) report configuration message indicating a plurality of channel state information reference signal (CSI-RS) resources for channel measurement and at least one zero-power or non-zero power CSI-RS resource for interference measurement, wherein each CSI-RS resource of the plurality of CSI-RS resources is associated with a CSI-RS resource indicator (CRI) and an identical number of CSI-RS ports;
performing a channel measurement procedure based on the CSI report configuration message;
selecting a set of CSI-RS resources from the plurality of CSI-RS resources for a joint transmission based on the channel measurement procedure; and
transmitting a CSI feedback message after the channel measurement procedure is performed, wherein the CSI feedback message includes a single rank indicator (RI), a single channel quality indicator (CQI), and a set of precoding matrix indicators (PMIs), wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

16. A processor for wireless communication, comprising:
at least one controller coupled with at least one memory and configured to cause the processor to:
receive a channel state information (CSI) report configuration message indicating a plurality of channel state information reference signal (CSI-RS) resources for channel measurement and at least one zero-power or non-zero power CSI-RS resource for interference measurement, wherein each CSI-RS resource of the plurality of CSI-RS resources is associated with a CSI-RS resource indicator (CRI) and an identical number of CSI-RS ports;
perform a channel measurement procedure based on the CSI report configuration message;
select a set of CSI-RS resources from the plurality of CSI-RS resources for a joint transmission based on the channel measurement procedure; and
transmit a CSI feedback message after the channel measurement procedure is performed, wherein the CSI feedback message includes a single rank indicator (RI), a single channel quality indicator (CQI), and a set of precoding matrix indicators (PMIs), wherein each PMI of the set of PMIs is associated with a respective CSI-RS resource in the selected set of CSI-RS resources, and wherein the RI indicates a rank applied to each CSI-RS resource of the selected set of CSI-RS resources, and the CQI indicates a channel quality associated with all CSI-RS resources in the selected set of CSI-RS resources.

17. The processor of claim 16, wherein each PMI of the set of PMIs is based on an eType 2 codebook, and includes a phase of a strongest frequency domain component of each data layer.

18. The processor of claim 17, wherein each PMI of the set of PMIs incorporates a number of phase adjustment factors, a total number of the phase adjustment factors equals a value of the RI, and each phase adjustment factor is associated with a data layer for the respective CSI-RS resource.

19. The processor of claim 18, wherein each phase adjustment factor is associated with all sub-bands.

20. The processor of claim 18, wherein each phase adjustment factor is associated with a respective sub-band.
